(19) United States
(12) Patent Application Publication
(10) Pub. No.: US 2013/0089670 A1
(43) Pub. Date: Apr. 11, 2013

(54) HYDROPHOBIC COATING MATERIAL AND METHOD FOR MANUFACTURING THE SAME

(71) Applicants: Yi-Che Su, Zhubei City (TW); Ya-Tin Yu, New Taipei City (TW); Yun-Shan Huang, Zhunan Township (TW); Wei-Cheng Tang, New Taipei City (TW); Yuung-Ching Sheen, Zhubei City (TW)

(72) Inventors: Yi-Che Su, Zhubei City (TW); Ya-Tin Yu, New Taipei City (TW); Yun-Shan Huang, Zhunan Township (TW); Wei-Cheng Tang, New Taipei City (TW); Yuung-Ching Sheen, Zhubei City (TW)

(21) Appl. No.: 13/464,765

(22) Filed: May 4, 2012

(30) Foreign Application Priority Data
Oct. 11, 2011 (TW) 100136706

(51) Int. Cl. B05D 5/00; B05D 3/00; C09D 5/00

(52) U.S. Cl. 427/372.2; 106/287.16

(57) ABSTRACT

A method of manufacturing a hydrophobic coating material, including: (a) mixing a siloxane precursor, water, and a catalyst to proceed with a sol-gel reaction to form a solution having particles therein, wherein the sol-gel reaction is performed without using any organic solvent; (b) chemically modifying the particles with a hydrophobic agent to form surface-modified particles; and (c) adding a surfactant to the solution containing the surface-modified particles to form a hydrophobic coating material. A hydrophobic coating material and a hydrophobic coating formed by the hydrophobic coating material are also provided. The hydrophobic coating material may preferably have a low VOC (Volatile organic compound) value, and may disperse in a water phase solution.

### CROSS REFERENCE TO RELATED APPLICATIONS

This Application claims priority of Taiwan Patent Application No. 100136706, filed on Oct. 11, 2011, the entirety of which is incorporated by reference herein.

### BACKGROUND OF THE DISCLOSURE

1. Field of the Invention

The present disclosure relates to a coating material, and in particular relates to a hydrophobic antifouling coating material and a method for manufacturing the same.

2. Description of the Related Art

In general, surfaces of all substrates are easily stained after use, and cleaning of some of them is very difficult or requires using highly corrosive detergents. Using these detergents might be harmful for humans and the environment. Therefore, various antifouling or self-cleaning materials have been developed to maintain cleanliness.

However, for today's processes for manufacturing antifouling coating materials, such as in a sol-gel reaction process, great amounts of organic solvents (such as alcohols, toluene, tetrahydrofuran, and etc.) are required. Thus, the resulting coating materials contain a high quantity of organic solvents (for example, over 90 wt%.) These coating materials have high volatile organic compound (VOC) value, for example, between 800 g/L and 900 g/L or even higher, therefore resulting in environmental pollution.

Conventionally, in a sol-gel reaction for manufacturing a hydrophobic antifouling coating material, the reaction must be performed in an organic solvent due to the reactants being unstable in an aqueous phase solution, or having phase separation or gelation problems. Although some waterborne resins, such as waterborne polyurethane (waterborne PU), have been used to perform a sol-gel reaction in an aqueous phase solution, some organic solvents are still required in the process to stabilize the reaction. In addition, the resulting coating materials usually have poor hydrophobicity, and therefore are not appropriate to be used as good antifouling materials. Furthermore, waterborne polyurethane has poor weather-resistance and hardness, and is not suitable to be used outdoors. Moreover, the molecular weight of the waterborne polyurethane is large and it has poor compatibility in existing systems, such that its applications are limited.

Therefore, a novel antifouling coating material with a low VOC value is now required.

### BRIEF SUMMARY OF THE DISCLOSURE

An embodiment of the disclosure provides a method of manufacturing a hydrophobic coating material, comprising: (a) mixing a siloxane precursor, water, and a catalyst to proceed with a sol-gel reaction to form a solution having particles therein, wherein the sol-gel reaction is performed without using any organic solvent; (b) chemically modifying the particles with a hydrophobic agent to form surface-modified particles; and (c) adding a surfactant to the solution containing the surface-modified particles to form a hydrophobic coating material.

Another embodiment of the disclosure provides a hydrophobic coating material manufactured by the previously described method.

Another embodiment of the disclosure provides a hydrophobic coating manufacturing method comprising the steps of: providing the previously described hydrophobic coating material; coating the hydrophobic coating material onto a substrate; and drying or curing the hydrophobic coating material to form a hydrophobic coating.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates a method for manufacturing a hydrophobic coating material according to one embodiment of the disclosure.

FIG. 2 illustrates a formula of step 102 of FIG. 1 according to one embodiment of the disclosure.

FIG. 3 illustrates a formula of step 104 of FIG. 1 according to one embodiment of the disclosure.

FIG. 4 illustrates a hydrophobic coating according to one embodiment of the disclosure.

### DETAILED DESCRIPTION OF THE DISCLOSURE

The following description is of the best-contemplated mode of carrying out the invention. This description is made for the purpose of illustrating the general principles of the invention and should not be taken in a limiting sense. The scope of the invention is best determined by reference to the appended claims.

Moreover, the formation of a first feature over and on a second feature in the description that follows may include embodiments in which the first and second features are formed in direct contact, and may also include embodiments in which additional features may be formed between the first and second features, such that the first and second features may not be in direct contact.

In one embodiment, a hydrophobic coating material which can be manufactured without using any organic solvents is provided. The coating material can be dispersed into an aqueous phase solution with a low VOC value and therefore is an eco-friendly coating material.

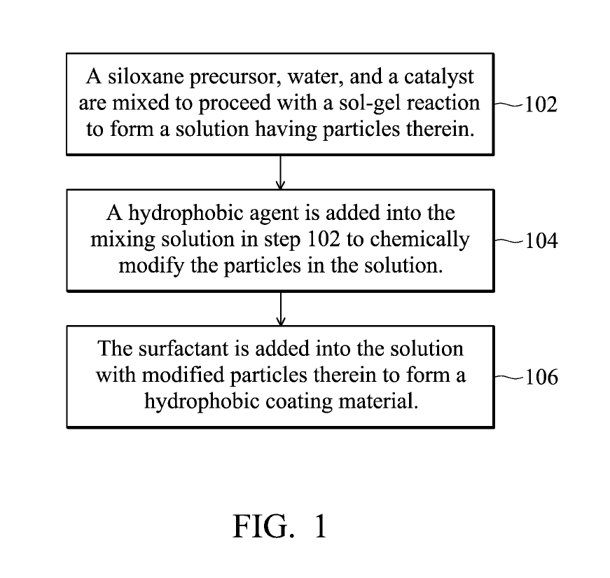

FIG. 1 illustrates a method for manufacturing a hydrophobic coating material according to one embodiment of the disclosure. Referring to FIG. 1, in step 102, a siloxane precursor, water, and a catalyst are mixed to proceed with a sol-gel reaction to form a solution having particles therein.

The siloxane precursor may have, for example, a —SiOR or —SiOH functional group, wherein R is CₙH₂ₙ₊₁, and n is a positive integer. Examples for the siloxane precursor may be tetramethoxysilane (TMOS), tetrathoxysilane (TEOS), titanium tetraisopropoxide, titanium tetramethoxide, titanium tetraethoxide, titanium tetrabutoxide, aluminum tri-sec-butoxide, or zirconium n-butoxide. The catalyst may be, for example, organic acid/base or inorganic acid/base, such as hydrochloric acid, sulfuric acid, nitric acid, acetic acid, potassium hydroxide, sodium hydroxide, ammonium, or the like.

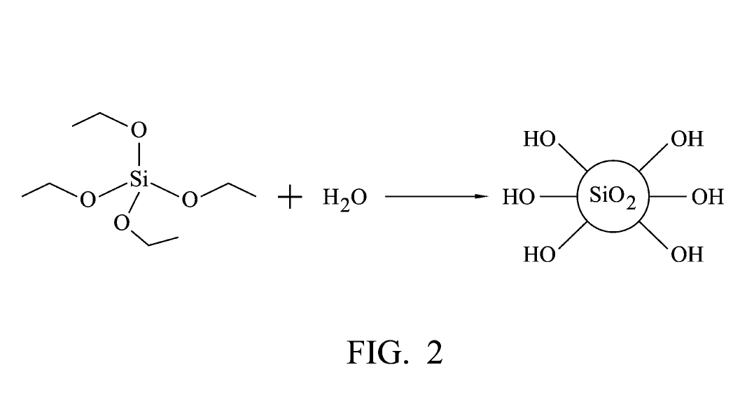

In addition, the sol-gel reaction in step 102 may not require any organic solvent, such that the resulting coating material can have a low VOC value. By contrast, an organic solvent is generally used in a conventional sol-gel reaction to stabilize the reactant. Furthermore, the conventional sol-gel reaction usually requires a long time, for example, six hours, at room temperature to complete the reaction. However, inventors of the present application found out that the sol-gel reaction is preferably reacted for about 1 hr to about 3.5 hrs without using the organic solvent. It has been confirmed by experiments that, in a sol-gel reaction process without using any organic solvent, the reactant may be less stable due to lack of the organic solvent, and when the reaction time is too long, for example, more than 3.5 hours, the mixed solution may become gelatinized or precipitated. However, if the reaction time is not long enough, for example, less than 1 hour, the sol-gel reaction may be incomplete. The reaction in step 102 may be performed at room temperature, for example, at 15° C. to 40° C. In one embodiment, the reaction in step 102 may have a formula as in FIG. 2, wherein the siloxane precursor is TEOS, for example.

Referring to FIG. 1, in step 104, a hydrophobic agent is added into the mixing solution in step 102 to chemically modify the particles in the solution. The hydrophobic agent may be, for examples, a silicon-based hydrophobic agent, a fluorine-base hydrophobic agent, a carbohydrate hydrophobic agent, a hydrocarbon hydrophobic agent, or combinations thereof. Examples of the silicon-based hydrophobic agent may be siloxane, silane, silicone, or combinations thereof. Examples of the fluorine-base hydrophobic agent may be fluorosilane, fluoroalkysilane, polytetrafluoroethylene (PTFE), polytrifluoroethylene, polyvinylfluroride, functional fluoroalkyl compound, or combinations thereof. Examples of the carbohydrate hydrophobic agent or the hydrocarbon hydrophobic agent may be reactive wax, polyethylene, polypropylene, or combinations thereof.

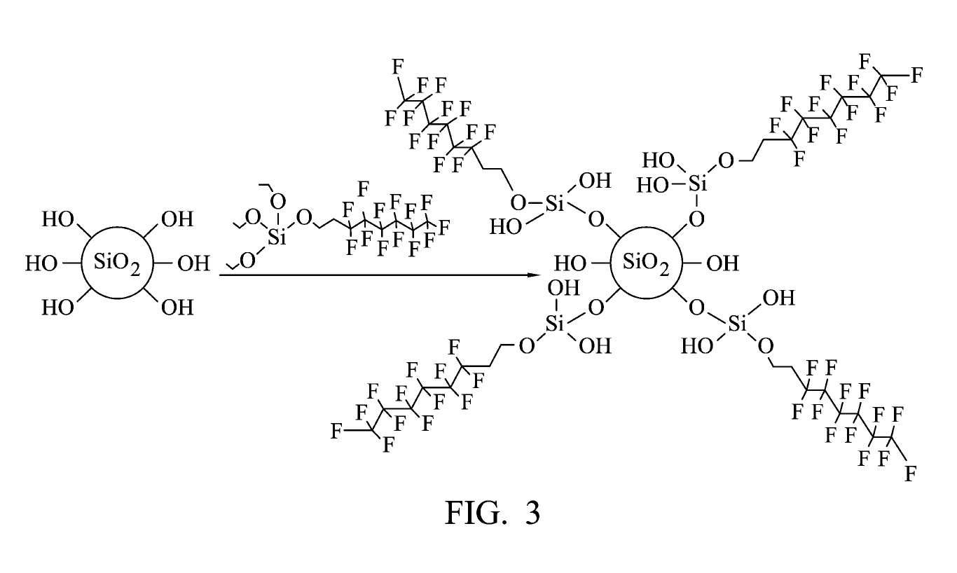

In step 104, since the hydrophobic agent and the solution having particles therein are separated into two layers (phases) after mixing, the chemical modifying reaction substantially occurs at the interface between the solution and the hydrophobic agent. After the reaction continues for a period of time, for example, after 1 hour to 2 hours, the hydrophobic agent may be substantially grafted to the particles. The reaction may be performed at room temperature, for example, at about 15° C. to 40° C. In one embodiment, the reaction in step 104 may be represented by the formula in FIG. 3, wherein the hydrophobic agent is 1H, 1H, 2H, 2H-perfluorodecyltriethoxysilane (F-8261, Degussa), for example.

Finally, in step 106 of FIG. 1, the surfactant is added into the solution with modified particles therein to form a hydrophobic coating material. The surfactant may be, for example, an anion surfactant, a combination of an anion surfactant and a cation surfactant, a combination of an anion surfactant and a non-ionic surfactant, a combination of anion surfactant and an amphoteric surfactant, or combinations thereof.

In step 106, the remaining hydrophobic agent is brought into the solution by the surfactant, such that the modification of the particles is completed. This step usually requires a longer reaction time, such as between 12 hours and 24 hours. By adding the surfactant, the resulting hydrophobic coating material (product) can be stable in an aqueous phase solution, and the product will not be separated into different phases due to the hydrophobic characteristics even after a period of time. In addition, the addition of the surfactant should be performed after the particles in the mixed solution are substantially modified. If the surfactant and the hydrophobic agent are added into the solution at the same time, not only will the particles not be modified completely but phase separation will occur.

In one embodiment, steps 102, 104, and 106 are performed with the following weight ratios: 0.01-30 parts by weight of the siloxane precursor; 50-99.9 parts by weight of the water; 0.01-5 parts by weight of the catalyst; 0.01-30 parts by weight of the hydrophobic agent; and 0.01-5 parts by weight of the surfactant. In addition, steps 102, 104, and 106 are performed without using any organic solvent. If there is too little surfactant, the modification reaction may be incomplete or the resulting product may not be able to be stable in an aqueous phase solution. However, if there is too much surfactant, the hydrophobicity of the resulting coating material may decrease and the cost of the process may increase.

A method for manufacturing a coating material in one embodiment includes steps 102, 104, and 106 in FIG. 1. In one embodiment, step 102 is performed without using any organic solvent. In another embodiment, steps 102, 104, and 106 are performed without using any organic solvent. The coating material may have a low VOC value by manufacturing by a sol-gel reaction without using any organic solvent, and the material can be used as an eco-friendly coating material.

Accordingly, by controlling the reaction time, a sol-gel reaction including mixing a siloxane precursor, water, and a catalyst to form a solution having particles therein may be performed without using any organic solvent such that the reactants will not be gelanized. Then, a hydrophobic agent is added into the mixture to chemically modify the particles. Since the hydrophobic agent and water is insoluble, the modification reaction substantially occurs at the interface. After most of the particles are modified, a surfactant is added into the solution such that the remaining hydrophobic agent will be brought into the solution and the modification reaction may be fully completed. In addition, the surfactant can help the resulting coating material be more stable in the aqueous phase solution and therefore the retention time of the coating material can be extended. However, if no surfactant is added into the solution which has the modified particles therein, the high hydrophobicity of the modified particles (for example, the particles with lots of fluorine in their structure) may cause the particles to be unstable in the aqueous phase solution, and therefore, the mixture may be separated into two layers after reacting for a certain period time and applications of the coating material may be limited. On the other hand, the coating material according to various embodiments of the disclosure can be stable in an aqueous phase solution due to the surfactant being added during the manufacturing process. Therefore, the coating material according to various embodiments of the disclosure can be used in a broader application. It should be appreciated that a little amount of organic solvent may also be used during the process when forming a coating material with low VOC value, and the scope of the disclosure is not intend to be limiting.

In addition, according to various embodiments of the disclosure, hydrophobic modified particles formed by chemical modification are stabilized in an aqueous phase solution by adding a surfactant. Therefore, compared to a method in which a hydrophobic material is simply absorbed on a surface (in other words, a non-chemical modification), the hydrophobic coating material according to various embodiments of the disclosure has better weather-resistance since its hydrophobic structures are chemically bonded onto the particles.

In one embodiment of the disclosure, a hydrophobic coating material not only has a much lower VOC value during a sol-gel reaction process, compatibility of the coating material with materials (such as aqueous materials, resins, paints, or the like) is also increased. For example, the hydrophobic coating material may be coated onto a substrate to form a hydrophobic coating. Advantages of the hydrophobic coating may include, but are not limit to, a high coating ability, adherence, hydrophobicity, antifouling, weather-resistance, solvent-resistance, and etc.

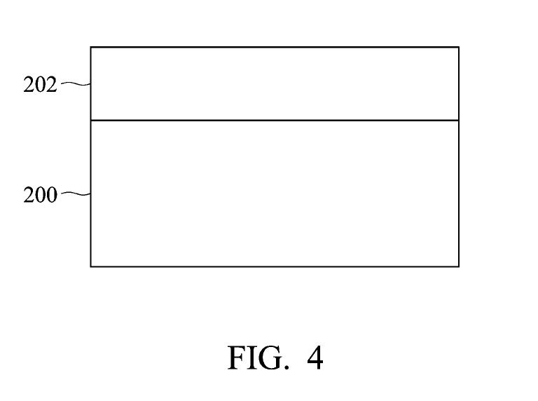

Referring to FIG. 4, the hydrophobic coating material is coated onto a substrate 200. The hydrophobic coating material is then dried or cured to form a hydrophobic coating 202. In one embodiment, the hydrophobic coating 202 is a transparent film with great adherence with the substrate 200. In addition, a surface of the hydrophobic coating 202 has a good hydrophobicity. For example, a water contact angle of the hydrophobic coating 202 is larger than 90°, or larger than 100°. Furthermore, the hydrophobic coating material of the disclosure can be used in various aspects such as being used as an additive of other coating materials or paints. For example, the hydrophobic coating material of the disclosure may be mixed with a second coating material to form a mixed coating material formula. Then, the mixed coating material formula is coated onto the substrate 200.

### EXAMPLES 1-8

### Manufacturing Hydrophobic Coating Materials

0.8 g of tetraethyl orthosilicate (TEOS), 0.277 g of water, and 0.32 g of HCl (0.1N) were mixed and reacted at room temperature for 3 hours. A solution having particles therein was obtained. Then, 0.8 g of 1H, 1H, 2H, 2H-perfluorodecyltriethoxysilane (F-8261, Degussa) was added into the mixture and reacted at room temperature for 2 hours, such that the particles were chemically modified. Next, 0.0384 g of sodium dodecyl sulfate (SDS) was dissolved in 24.94 g of water and added into the solution having the modified particles as an anion surfactant. The reaction was performed at room temperature for 12 hours to form a hydrophobic coating material which was stable in an aqueous solution. Then, the hydrophobic coating material was coated onto a glass substrate and baked at 120° C. for 30 minutes. After the coating was cooled down, the water contact angle of the coating of 116° was measured.

Table 1 illustrates results of various examples and comparative examples. The hydrophobic agents F-8261 and 7806 can be represented by following formula:

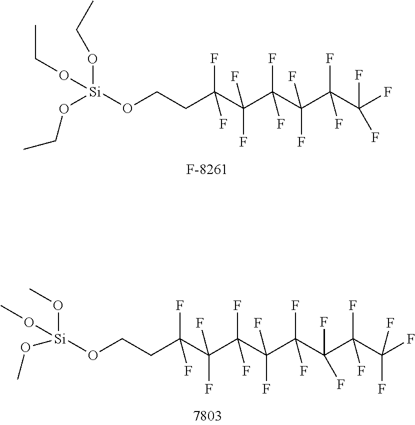 [SMILES: CCO[Si](OCC)(OCC)OCCC(F)(F)C(F)(F)C(F)(F)C(F)(F)C(F)(F)C(F)(F)F ; CO[Si](OC)(OC)OCCC(F)(F)C(F)(F)C(F)(F)C(F)(F)C(F)(F)C(F)(F)C(F)(F)C(F)(F)F]

In addition, surfactant DC 190 refers to a non-ionic surfactant DOW CORNING® 190 FLUID (bought from DOW CORNING), which includes 40 wt % to 60 wt % of dimethyl, methyl(propyl(poly(EO)(PO))acetate) siloxane; 30 wt % to 50 wt % of poly(ethylene oxide propylene oxide) monoallyl ether acetate; and less than 9 wt % of polyelther acetate. CATB refers to cetyl trimethyl ammonium bromide, which is a cation surfactant. EnviroGem 360 was bought from Air products. AQ55S was bought from Eastman, which is an anion surfactant. AQ55S had following formula, wherein A is dicarboxylic acid moiety, G is glycol moiety.

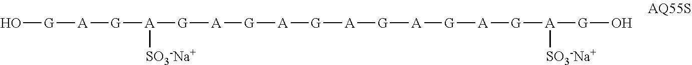

SDBS refers to sodium dodecylbenzene sulfate, which is an anion surfactant. DSS refers to dioctyl sodium sulfosuccinate, which is an anion surfactant.

In examples 1 to 8, sol-gel reactions were performed without using any organic solvent, and an anion surfactant (such as SDS, AQ55S, SDBS, or DSS) or combinations thereof was added into the reaction, such that products which were stable in an aqueous phase solution and had great hydrophobicity (water contact angle>100°) were obtained.

In comparative example 1, TEOS, water, HCl, and organic solvent (isopropyl alcohol) were mixed to perform a sol-gel reaction. In comparative examples 2 to 6, sol-gel reactions were also performed without using any organic solvent. However, in comparative example 2, no surfactant was used. In comparative example 3, only a non-ionic surfactant (AQ55S) was used. In comparative example 4, only a cation surfactant (DC190) was used. In comparative example 5, only a commercial surfactant (EnviroGem 360) was used. In comparative example 6, the commercial coating material EVONIL (Dynasylan® SIVO 112) was used for comparison with the coating materials of examples 1 to 8.

Referring to Table 1, according to examples 1 to 8, hydrophobic coating materials which were stable in an aqueous phase solution and had great hydrophobicity were manufactured in the sol-gel reactions without using any organic solvent by adding an appropriate amount of anion surfactant or combinations thereof during the manufacturing process. On the contrary, according to comparative example 2, the resulting coating material which was formed without adding any surfactant during the process was unstable in an aqueous phase solution, such that the coating material of comparative example 2 was not able to be coated onto the glass substrate. Moreover, according to comparative examples 3 to 5, although the stability can be improved by adding some surfactants, hydrophobicity of the coating materials of comparative examples 3 to 5 were poor resulting from not using any anion surfactant. In comparative example 6, a commercial coating material was coated onto a substrate, but the hydrophobicity of the coating materials of comparative example 6 was still not as good as the hydrophobicity of the coating materials of examples 1 to 8.

TABLE 1

| | | | | | Hydrophobic | | | | |
|---|---|---|---|---|---|---|---|---|---|
| | | | 0.1N | Organic | agent | | Surfactant | | |
| | TEOS | Water | HCl | solvent | F-8261 | 7803 | SDS | DC190 | CATB |
| Example 1 | 0.8 | 25.22 | 0.32 | 0 | 0.8 | 0 | 0.0384 | 0 | 0 |
| Example 2 | 0.8 | 25.22 | 0.32 | 0 | 0 | 0.8 | 0.0384 | 0 | 0 |
| Example 3 | 0.8 | 28.329 | 0.32 | 0 | 0.8 | 0 | 0 | 0 | 0 |
| Example 4 | 0.8 | 28.329 | 0.32 | 0 | 0.8 | 0 | 0.0192 | 0.0192 | 0 |
| Example 5 | 0.8 | 25.22 | 0.32 | 0 | 0.8 | 0 | 0.03456 | 0 | 0.00384 |
| Example 6 | 0.8 | 28.329 | 0.32 | 0 | 0.8 | 0 | 0.00384 | 0 | 0 |
| Example 7 | 0.8 | 25.22 | 0.32 | 0 | 0.8 | 0 | 0 | 0 | 0 |
| Example 8 | 0.8 | 25.22 | 0.32 | 0 | 0.8 | 0 | 0 | 0 | 0 |
| Comparative | 0.8 | 25.22 | 0.32 | 28.05 | 0.8 | 0 | 0 | 0 | 0 |
| example 1 | | | | (IPA) | | | | | |
| Comparative | 0.8 | 25.22 | 0.32 | 0 | 0.8 | 0 | 0 | 0 | 0 |
| example 2 | | | | | | | | | |
| Comparative | 0.8 | 28.329 | 0.32 | 0 | 0.8 | 0 | 0 | 0.0384 | 0 |
| example 3 | | | | | | | | | |
| Comparative | 0.8 | 25.22 | 0.32 | 0 | 0.8 | 0 | 0 | 0 | 0.0384 |
| example 4 | | | | | | | | | |
| Comparative | 0.8 | Glass | 0.32 | 0 | 0.8 | 0 | 0 | 0 | 0 |
| example 5 | | | | | | | | | |

| | |
|---|---|
| Comparative | EVONIK (Dynasylan ® SIVO 112) Waterborne |
| example 6 | |

| | Surfactant | | | | | | Water |
|---|---|---|---|---|---|---|---|
| | | Enviro | | | | | contact |
| | | Gem | | | | | angle |
| | AQ 55S | 360 | SDBS | DSS | Substrate | Stability | (°) |
| Example 1 | 0 | 0 | 0 | 0 | Glass | Stable | 116 |
| Example 2 | 0 | 0 | 0 | 0 | Glass | Stable | 108 |
| Example 3 | 0.1536 | 0 | 0 | 0 | Glass | Stable | 106 |
| Example 4 | 0 | 0 | 0 | 0 | Glass | Stable | 112 |
| Example 5 | 0 | 0 | 0 | 0 | Glass | Stable | 109 |
| Example 6 | 0 | 0.03456 | 0 | 0 | Glass | Stable | 115 |
| Example 7 | 0 | 0 | 0.0384 | 0 | Glass | Stable | 113 |
| Example 8 | 0 | 0 | 0 | 0.0384 | Glass | Stable | 110 |
| Comparative | 0 | 0 | 0 | 0 | Glass | Stable | 115 |
| example 1 | | | | | | | |
| Comparative | 0 | 0 | 0 | 0 | — | Layered | — |
| example 2 | | | | | | | |
| Comparative | 0 | 0 | 0 | 0 | Glass | Stable | 26 |
| example 3 | | | | | | | |
| Comparative | 0 | 0 | 0 | 0 | Glass | Stable | 48 |
| example 4 | | | | | | | |
| Comparative | 0 | 0.0384 | 0 | 0 | Glass | Stable | 44 |
| example 5 | | | | | | | |

| | | | | |
|---|---|---|---|---|
| Comparative | EVONIK (Dynasylan ® | Glass | Stable | 88 |
| example 6 | SIVO 112) Waterborne | | | |

### EXAMPLE 9

### VOC Value of Hydrophobic Coating Materials

VOC values of the hydrophobic coating materials of example 1 and comparative example 1 were tested and calculated according to ISO 11890-2 (10.3 Method 2). The results are shown in Table 2.

TABLE 2

| | VOC value |
|---|---|
| Example 1 | 97 g/L |
| Comparative example 1 | 754 g/L |

Referring to Table 2, the hydrophobic coating of example 1, compared to the hydrophobic coating of comparative example 1, had a low VOC value. In the manufacturing process of the hydrophobic coating of the example 1, no organic solvent was used, and the very low VOC value resulted from a byproduct (ethanol) of the sol-gel reaction. Therefore, the eco-friendly hydrophobic coating was formed accordingly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of manufacturing a hydrophobic coating material, comprising
(a) mixing a siloxane precursor, water, and a catalyst to proceed with a sol-gel reaction to form a solution having particles therein, wherein the sol-gel reaction is performed without using any organic solvent;
(b) chemically modifying the particles with a hydrophobic agent to form surface-modified particles; and
(c) adding a surfactant to the solution containing the surface-modified particles to form a hydrophobic coating material.

2. The method of manufacturing a hydrophobic coating material as claimed in claim 1, wherein steps (a), (b), and (c) are performed with the following weight ratios:
0.01-30 parts by weight of the siloxane precursor;
50-99.9 parts by weight of the water;
0.01-5 parts by weight of the catalyst;
0.01-30 parts by weight of the hydrophobic agent; and
0.01-5 parts by weight of the surfactant.

3. The method of manufacturing a hydrophobic coating material as claimed in claim 1, wherein steps (a), (b), and (c) are performed with the absence of any organic solvent.

4. The method of manufacturing a hydrophobic coating material as claimed in claim 1, wherein the siloxane precursor has a —SiOR or —SiOH functional group, wherein R is CₙH₂ₙ₊₁, and n is a positive integer.

5. The method of manufacturing a hydrophobic coating material as claimed in claim 1, wherein the hydrophobic agent comprises a silicon-based hydrophobic agent, a fluorine-base hydrophobic agent, a carbohydrate hydrophobic agent, a hydrocarbon hydrophobic agent, or combinations thereof.

6. The method of manufacturing a hydrophobic coating material as claimed in claim 1, wherein the surfactant comprises an anion surfactant, a combination of an anion surfactant and a cation surfactant, a combination of an anion surfactant and a non-ionic surfactant, a combination of anion surfactant and an amphoteric surfactant, or combinations thereof.

7. The method of manufacturing a hydrophobic coating material as claimed in claim 1, wherein step (a) is performed at 15° C. to 40° C. for 1 hr to 3.5 hrs.

8. The method of manufacturing a hydrophobic coating material as claimed in claim 1, wherein step (c) is performed at 15° C. and 40° C. for 12 hrs to 24 hrs.

9. A hydrophobic coating material manufactured by the method as claimed in claim 1.

10. A hydrophobic coating manufacturing method comprising the steps of:
providing a hydrophobic coating material as claimed in claim 9;
coating the hydrophobic coating material onto a substrate; and
drying or curing the hydrophobic coating material to form a hydrophobic coating.

11. The hydrophobic coating as claimed in claim 10, wherein a water contact angle of the hydrophobic coating is larger than 90°.

12. The hydrophobic coating as claimed in claim 10, further comprising, before coating the hydrophobic coating material onto the substrate, mixing the hydrophobic coating material with a second coating material to form a mixed coating material formula, and then coating the mixed coating material formula onto the substrate.
